(19) United States
(12) Patent Application Publication
(10) Pub. No.: US 2014/0183418 A1
(43) Pub. Date: Jul. 3, 2014

(54) Carbon Fiber Reinforced Polyoxymethylene for Printer Spindles

(71) Applicant: Ticona LLC, Florence, KY (US)

(72) Inventors: Jeremy Hager Klug, Union, KY (US); Jaiwei Li, Shanghai (CN)

(73) Assignee: Ticona LLC, Florence, KY (US)

(21) Appl. No.: 14/096,190

(22) Filed: Dec. 4, 2013

Related U.S. Application Data
(60) Provisional application No. 61/746,221, filed on Dec. 27, 2012.

(51) Int. Cl. H01B 1/24; B41F 17/00

(52) U.S. Cl. CPC H01B 1/24; B41F 17/00
USPC 252/511

(57) ABSTRACT

Polymer compositions containing a polyoxymethylene base polymer that is compounded with a conductive filler. The polymer composition is formulated so as to increase the electrically conductivity of the polymer composition and articles formed therefrom while at the same time having a high enough stiffness via the addition of a conductive filler. The polyoxymethylene base polymer has a melt flow rate ranging from about 15 grams per 10 minutes to about 50 grams per 10 minutes at 190° C. and a 2.6 kilogram load in accordance with ASTM D1238-82. Further, the polymer composition has a modulus of from about 10,000 MPa to about 20,000 MPa. The polymer composition can be used to form molded parts such as printer spindles where conductivity, wear resistance, and stiffness are required.

### RELATED APPLICATIONS

The present application claims priority to U.S. Provisional Application Ser. No. 61/746,221, filed on Dec. 27, 2012, which is incorporated herein in its entirety by reference thereto.

### BACKGROUND OF THE INVENTION

A laser printer produces high quality text and graphics on paper by a digital printing process. During this process, an image is produced via the direct scanning of a laser beam across the printer's photoreceptor. More specifically, a laser beam projects an image of the page to be printed onto an electrically charged rotating drum that has been coated with selenium or organic photoconductors, for example. Because of photoconductivity, charge leaks away from the areas exposed to light. Then, the toner particles are then electrostatically picked up by the drum's charged areas, and the drum prints the image onto paper by direct contact and heat, which fuse the ink to the paper. Typically, the toner particles are applied to the drum by a rubber toner metering roll. The toner metering roll must be charged to facilitate the transfer of the toner particles to the drum, thus spindle upon which the toner metering roll rests must be electrically conductive. Further, the spindle must not wear as it generally rides in acetal/polyoxymethylene bushings. In addition, the spindle metering roll must be imparted with a certain level of stiffness so that it does not bend easily, as bending of the roll could cause the laser printer to malfunction. Thus, a typical metering roll is composed of a spindle that includes a metal rod (i.e., a steel rod) surrounded by a conductive sleeve around which a rubber roller sleeve is applied. However, these spindles can be expensive, and there is an interest in replacing the standard steel and conductive sleeve spindle combination with a spindle formed from a single material.

In view of the above, a need exists for a conductive polymeric material that is also exhibits wear resistance and stiffness so that it can be used in a laser printer spindle.

### SUMMARY OF THE INVENTION

Generally speaking, the present disclosure is directed to a polyoxymethylene composition comprising a base polyoxymethylene and carbon fibers. The polymer composition has a melt flow rate of from about 4 grams per 10 minutes to about 16 grams per 10 minutes at 190° C. and a 2.16 kilogram load and a modulus of from about 10,000 MPa to about 20,000 MPa.

In one embodiment, the base polyoxymethylene can have a melt flow rate of from about 15 grams per 10 minutes to about 50 grams per 10 minutes at 190° C. and a 2.16 kilogram load. In another embodiment, the base polyoxymethylene can be present in the polymer composition in an amount ranging from about 70% by weight to about 89% by weight based on the total weight of the polymer composition.

In yet another embodiment, the carbon fibers can be present in an amount ranging from about 11% by weight to about 30% by weight based on the total weight of the polymer composition. Further, the carbon fibers can have a fiber diameter of from about 0.5 micrometers to about 25 micrometers. The carbon fibers can also have a fiber length of from about 50 micrometers to about 2500 micrometers. Additionally, the carbon fibers can be treated with a sizing agent. The sizing agent can be present in an amount ranging from about 0.5% by weight to about 15% by weight based on the total weight of the carbon fibers present.

In still another embodiment, the polymer composition can further comprise an antioxidant. The antioxidant can be present in an amount ranging from about 0.01% by weight to about 1% by weight based on the total weight of the polymer composition. In yet another embodiment, the polymer composition can further comprise a formaldehyde scavenger. The formaldehyde scavenger can be present in an amount ranging from about 0.01% by weight to about 1% by weight based on the total weight of the polymer composition. Further still, the polymer composition can comprise a nucleant. The nucleant can be present in an amount ranging from about 0.01% by weight to about 2% by weight based on the total weight of the polymer composition. The polymer composition can also comprise a lubricant. The lubricant can be present in an amount ranging from about 0.01% by weight to about 1% by weight based on the total weight of the polymer composition. A compatibilizer can also be included in the polymer composition of the present disclosure. The compatibilizer can be present in an amount ranging from about 0.01% by weight to about 1% by weight based on the total weight of the polymer composition.

In one embodiment, polymer composition can have a surface resistance of less than about 10⁶ Ohms. In yet another embodiment, the polymer composition can have a volume resistivity of less than 100 Ohm-cm. Further, a shaped article can be formed from the polymer composition. In one particular embodiment, the shaped article is a printer spindle. The printer spindle is utilized in a laser printer toner cartridge. In addition, the shaped article, when subjected to a 2-3 kilogram laterally applied load, has a deflection of less than about 0.1 millimeters in a direction perpendicular to the direction of the laterally applied load,

Other features and aspects of the present disclosure are discussed in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figure, in which:

FIG. 1 shows a laser printer spindle from the prior art;

FIG. 2 shows a laser printer spindle formed from the polymer composition of the present disclosure; and

FIG. 3 shows a spindle formed from the polymer composition of the present disclosure as a component of a laser printer apparatus.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polyoxymethylene-based polymer composition that is well suited to being molded into articles that are electrically conductive, have exceptional wear resistance, and exhibit sufficient stiffness when subjected to a laterally applied load. The polymer composition is formulated so as to increase the electrically conductivity of the polymer composition and articles formed therefrom while at the same time having a high enough stiffness via the addition of a conductive filler. The polyoxymethylene utilized can have a melt flow rate ranging from about 15 grams per 10 minutes to about 50 grams per 10 minutes, such as from about 20 grams per 10 minutes to about 45 grams per 10 minutes, such as from about 25 grams per 10 minutes to about 40 grams per 10 minutes at 190° C. and a 2.6 kilogram load in accordance with ASTM D1238-82. Further, the polymer composition as a whole can have a melt flow rate ranging from about 4 grams per 10 minutes to about 16 grams per 10 minutes, such as from about 6 grams per 10 minutes to about 14 grams per 10 minutes, such as from about 8 grams per 10 minutes to about 12 grams per 10 minutes at 190° C. and a 2.6 kilogram load in accordance with ASTM D1238-82. Without intending to be limited by theory, it is believed that the melt flow rate of the polymer composition, as controlled at least in part by the melt flow rate of the base polyoxymethylene, is sufficiently high to permit an increased amount of the conductive filler component of the composition to migrate towards the surface of articles formed from the polymer, which, in turn, results in the articles exhibiting increased electrical conductivity. For instance, articles formed from the polymer composition of the present disclosure can have a resistance of less than about 10⁶ Ohms, such as less than about 10⁵ Ohms, such as less than about 10⁴ Ohms, such as less than about 10³ Ohms. Additionally, articles formed from the polymer composition of the present disclosure can have a volume resistivity of less than about 100 Ohm-cm, such as less than about 10 Ohm-cm, such as less than about 5 Ohm-cm, such as less than about 2.5 Ohm-cm. In one particular embodiment, the volume resistivity can be less than about 1 Ohm-cm.

Further, rods such as printer spindles formed from the polymer composition can have a maximum deflection of less than about 0.10 millimeters, such as less than about 0.075 mm, such as less than about 0.05 mm when subjected to a laterally applied load ranging from about 2 kilograms to about 3 kilograms of pressure. In addition, the polymer composition can have a modulus ranging from about 10,000 megapascals (MPa) to about 20,000 MPa, such as from about 11,000 MPa to about 18,000 MPa, such as from about 12,000 MPa to about 16,000 MPa. Meanwhile, the polymer composition can have a tensile strength of from about 74 MPa to about 100 MPa, such as from about 76 MPa to about 95 MPa, such as from about 78 MPa to about 90 MPa.

As a result of the aforementioned characteristics, the polymer composition can be formed into a laser printer spindle that is part of a toner cartridge, although it is to be understood that the polymer composition can also be used to form articles suitable for use in any other application where electrical conductivity, stiffness, and wear resistance are desired characteristics. For instance, the polymer composition of the present disclosure can be utilized in forming other spindles that are employed in laser printing systems or inkjet printing systems.

Generally, the polymer composition achieves the characteristics discussed above via the combination of a polyoxymethylene, a conductive filler, and optional additives. It should be noted that unlike other electro-conductive compositions, however, absent from the polymer composition of the present disclosure is a coupling agent. The polymer composition can be formed into any article where electrical conductivity, stiffness, and wear resistance are required. The article can be formed by molding techniques known in the art such as extrusion, injection molding, thermoforming, blow molding, rotational molding, etc.

More particularly, the polymer composition of the present disclosure comprises a base polyoxymethylene, a conductive filler, and optional additives that can be formed into a molded article. The combination of the base polyoxymethylene with the conductive filler has been found to provide for sufficient wear resistance and stiffness while at the same time producing an article with a high enough level of electrical conductivity to be utilized in an article such as a printer spindle in the toner cartridge of a laser printer. The composition can also be used to form any other article requiring electrical conductivity that is also stiff and wear resistant.

The components of polymer composition will now be discussed in more detail. First, the base polyoxymethylene can be a generally unbranched linear polymer containing at least 80%, such as at least 90%, of oxymethylene units (—CH₂O—). Further, the base polyoxymethylene can have a melt flow rate of from about 15 grams per 10 minutes to about 50 grams per 10 minutes, such as from about at 20 grams per 10 minutes to about 45 grams per 10 minutes, such as from about 25 grams per 10 minutes to about 40 grams per 10 minutes at 190° C. and a 2.6 kilogram load in accordance with ASTM D1238-82. The base polyoxymethylene can be present in the polymer composition in an amount ranging from about 70% by weight to about 89% by weight, such as in an amount ranging from about 75% by weight to about 88% by weight, such as in an amount ranging from about 78% by weight to about 87% by weight based on the total weight of the polymer composition.

The conductive filler can include conductive particles, powders, fibers or combinations thereof. For instance, the conductive filler may comprise carbon fibers, carbon powder, electro-conductive (EC) carbon black, carbon nanotubes, metal powders, metal flakes, metal fibers, or combinations thereof. Further, the conductive filler can be present in the polymer composition in an amount ranging from about 11% by weight to about 30% by weight, such as in an amount ranging from about 12% by weight to about 25% by weight, such as in an mount ranging from about 13% by weight to about 22% by weight based on the total weight of the polymer composition.

In addition to the components discussed above, the polymer composition can contain various additives such as nucleants, lubricants, antioxidants, UV light absorbers, light stabilizers, formaldehyde scavengers, acid scavengers, compatibilizers, etc. These components can each be present in the composition in an amount less than about 2% by weight, such as in an amount less than about 1.5% by weight, such as in an amount less than about 1.0% by weight based on the total weight of the polymer composition.

As described above, the polymer composition of the present disclosure renders a standard polyoxymethylene electrically conductive that at the same time is stiff enough and sufficiently wear resistant to be utilized as a spindle. Of particular advantage, molded parts made from the disclosed polymer composition are well suited for use in business machine applications where electrical conductivity, stiffness, and wear resistance are required. For instance, the polymer composition can be molded into laser printer toner cartridge spindles. Further, the molded parts made from the polymer composition described above are laser weldable in that they can absorb the incident energy from the laser and covert this to heat efficiently. Generally, the polymer composition of the present disclosure contains a base polyoxymethylene, a conductive filler, and optional additives, and each of these components are discussed in more detail below.

### Base Polyoxymethylene

In the present disclosure, the base polyoxymethylene to be rendered electrically conductive is generally an unbranched linear polymer that contains at least 80%, such as at least 90%, of oxymethylene units (—CH₂O—). It should be understood that the term polyoxymethylene here encompasses homopolymers of formaldehyde or of its cyclic oligomers, such as trioxane or tetroxane, and also corresponding copolymers, terpolymers and the like.

Polyoxymethylene homopolymers are prepared conventionally by polymerizing anhydrous formaldehyde or the trimer, trioxane. Polyoxymethylenes of suitable molecular weight for use herein may be prepared by polymerizing trioxane in the presence of Lewis acid catalysts such as antimony fluoride or boron trifluoride.

As is well known, ex reactor polyoxymethylene is stabilized predominantly by either end capping (e.g., acetylation of terminal hemiacetal via ester or ether groups) or by hydrolysis.

In one embodiment, polyoxymethylene copolymers with a proportion of 60% to 99.9% of recurring units being oxymethylene interspersed with the balance of oxy(higher alkylene) groups can be used to form the base polyoxymethylene. Oxy(higher alkylene) groups are introduced via cyclic ether or cyclic formal having at least two adjacent carbon atoms in the ring in addition to trioxane, such as via ethylene oxide 1,3-dioxolane with trioxane. Mention may be made of cyclic ethers ethylene oxide, propylene 1,2-oxide, butylene 1,2-oxide, butylene 1,3-oxide, 1,3-dioxane, 1 ,3-dioxolane, and 1,3-dioxepan, and also linear oligo- or polyformals, such as polydioxolane or polydioxepan as comonomers. The polyoxymethylene resins used herein have a number average molecular weight of at least 10,000 and I.V. of least 1.0 (at 25 ° C. in a 0.2 wt. % solution in hexafluoroisopropanol). Additionally, the polyoxymethylene copolymers have melting points of at least 150° C. and a weight average molecular weight ranging from about 5000 to about 200,000, such as from about 7000 to about 150,000. Particular preference is given to end-group-stabilized polyoxymethylene polymers which have carbon-carbon bonds at the ends of the chains. Useful polyoxymethylene resins are crystalline, and have a melt flow rate of from about 15 grams per 10 minutes to about 50 grams per 10 minutes, such as from about 20 grams per 10 minutes to about 45 grams per 10 minutes, such as from about 25 grams per 10 minutes to about 40 grams per 10 minutes at 190° C. and a 2.16 kilogram load in accordance with ASTM D1238-82.

The base polyoxymethylene can be present in the polymer composition in an amount ranging from about 70% by weight to about 89% by weight, such as in an amount ranging from about 75% by weight to about 88% by weight, such as in an amount ranging from about 78% by weight to about 87% by weight based on the total weight of the polymer composition.

### Conductive Filler

Further, the base polyoxymethylene is compounded with a conductive filler such that the polymer composition of the present disclosure can have sufficient conductivity and stiffness. The conductive filler can include conductive fibers, particles, powders, or combinations thereof. For instance, the conductive filler may comprise carbon fibers, carbon black, carbon nanotubes, metal powders, metal flakes, metal fibers, carbon powder, or combinations thereof. However, the present inventors have found that by using carbon fibers, for example, an electrically conductive polymer composition also having sufficient stiffness and wear resistance can be achieved. When fibers are utilized, the fibers can have a fiber diameter ranging from about 0.5 micrometers (μm) to about 25 μm, such as from about 1 μm to about 20 μm, such as from about 5 μm to about 15 μm. Further, the fibers can have a fiber length ranging from about 50 micrometers to about 2500 micrometers, such as from about 75 micrometers to about 2000 micrometers, such as from about 100 micrometers to about 1500 micrometers.

When electrically conductive fibers such as carbon fibers are utilized in the polymer composition of the present disclosure, the fibers may be in modified or unmodified form in that the fibers can be provided with a sizing or chemically treated in order to improve adhesion to the base polyoxymethylene. The sizing agent can protect the fibers, smooth the fibers, and improve the adhesion between the fibers and the base polyoxymethylene. The sizing agent can comprise silanes, film forming agents, lubricants, wetting agents, adhesives, antistatic agents, plasticizers, emulsifiers, and other additives. Suitable examples of silanes can include aminosilanes such as 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, or N[3-(trimethoxysilyl)propyl]-1,2-ethane-diamine, Meanwhile, suitable examples of film forming agents can include polyvinylacetates, polyesters and polyurethanes. The amount of sizing agent present on the conductive fibers (i.e., carbon fibers) can vary, such as from about 0.5% by weight to about 15% by weight, such as from about 1% by weight to about 10% by weight, such as from about 1,5% by weight to about 7.5% by weight based on the total weight of the conductive fibers present in the polymer composition.

Further, the conductive filler can be present in the polymer composition of the present disclosure in an amount ranging from about 11% by weight to about 30% by weight, such as in an amount ranging from about 12% by weight to about 25% by weight, such as in an amount ranging from about 13% by weight to about 22% by weight, based on the total weight of the polymer composition.

### Additional Additives

In addition to the base polyoxymethylene and the conductive filler, discussed above, the polymer composition of the present disclosure can also contain additives such as, for example, antioxidants, formaldehyde scavengers, acid scavengers, UV stabilizers or heat stabilizers. In addition, the composition can contain processing auxiliaries, for example adhesion promoters, lubricants, nucleants, demolding agents, fillers, reinforcing materials, or antistatic agents and additives which impart a desired property to the articles formed from the polymer composition.

For instance, in one embodiment, an ultraviolet light stabilizer may be present. The ultraviolet light stabilizer may comprise a benzophenone, a benzotriazole, or a benzoate. Particular examples of ultraviolet light stabilizers include 2,4-dihydroxy benzophenone, 2-hydroxy-4-methoxybenzophenone, 2-(2′-hydroxy-3′,5′-di-t-butylphenyl)benzotriazole, 2-(2′-hydroxy-3′-t-butyl-5′-methylphenyl)-5-chlorobenzotriazole, 2,4-dihydroxybenzophenone, 2-hydroxy-4-methoxybenzophenone, 2-hydroxy-4-octoxybenzophenone, and 5,5′-methylene bis(2-hydroxy-4-methoxybenzophenone); 2-(2′-hydroxyphenyl)benzotriazoles, e.g. 2-(2′-hydroxy-5′-methylphenyl)benzotriazole, 2-(2′-hydroxy-5′-t-octylphenyl)benzotriazole, 2-(2′-hydroxy-3′,5′-di-t-butylphenyl)benzotriazole, hydroxy-3′,5′-di-t-butylphenyI)-5-chlorobenzotriazole, 2-(2′-hydroxy-3′-t-butyl-5′-methylphenyl)-5-chlorobenzotriazole, 2-(2′-hydroxy-3′,5′-dicumylphenyl)benzotriazole, and 2,2′-methylene bis(4-t-octyl-6-benzotriazolyl)phenol, phenylsalicylate, resorcinol monobenzoate, 2,4-di-t-butylphenyl-3′,5′-di-t-butyl-4′-hydroxybenzoate, and hexadecyl-3,5-di-t-butyl-4-hydroxybenzoate; substituted oxanilides, e.g. 2-ethyl-2′-ethoxyoxanilide and 2-ethoxy-4′-dodecyloxanilide; cyanoacrylates, e.g. ethyl-α-cyano-β,β-diphenylacrylate and methyl-2-cyano-3-methyl-3-(p-methoxyphenyl)ac late or mixtures thereof. A specific example of an ultraviolet light absorber that may be present is UV 234, which is a high molecular weight ultraviolet light absorber of the hydroxyl phenyl benzotriazole class. The UV light absorber, when present, can be present in the polymer composition in an amount ranging from about 0.01% by weight to about 1% by weight, such as in an amount ranging from about 0.05% by weight to about 0,75% by weight, such as in an amount ranging from about 0,075% by weight to about 0.5% by weight based on the total weight of the polymer composition.

In one embodiment, the polymer composition may also include a formaldehyde scavenger, such as a nitrogen-containing compound. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Advantageous compounds of this nature are aminopyridine and compounds derived therefrom. Any of the aminopyridines is in principle suitable, for example 2,6-diaminopyridine, substituted and dimeric aminopyridines, and mixtures prepared from these compounds. Other advantageous materials are polyamides and dicyane diamide, urea and its derivatives and also pyrrolidone and compounds derived therefrom. Examples of suitable pyrrolidones are imidazolidinone and compounds derived therefrom, such as hydantoines, derivatives of which are particularly advantageous, and those particularly advantageous among these compounds are allantoin and its derivatives. Other particularly advantageous compounds are triamino-1,3,5-triazine (melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger can be a guanidine compound which can include an aliphatic guanamine-based compound, an alicyclic guanamine-based compound, an aromatic guanamine-based compound, a hetero atom-containing guanamine-based compound, or the like. The formaldehyde scavenger can be present in the polymer composition in an amount ranging from about 0.01% by weight to about 1% by weight, such as in an amount ranging from about 0.05% by weight to about 0.75% by weight, such as in an amount ranging from about 0.075% by weight to about 0.5% by weight based on the total weight of the polymer composition.

In one embodiment, the composition may also contain a nucleant. The nucleant may increase crystallinity and may comprise an oxymethylene terpolymer. In one particular embodiment, for instance, the nucelant may comprise a terpolymer of butanediol diglycidyl ether, ethylene oxide, and trioxane. The nucleant can be present in the composition in an amount ranging from about 0.01% by weight to about 2% by weight, such as in an amount ranging from about 0.05% by weight to about 1.5% by weight, such as in an amount ranging from about 0.1% by weight to about 1% a by weight based on the total weight of the polymer composition.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (IRGANOX® 1010, BASF), triethylene glycol bis[3-(3-tert-butyl-4-hydroxy-5-methylphenyppropionate] (IRGANOX® 245, BASF), 3,3′-bis[3-(3,5-di-tert-butyl-4-hydroxyphenyl)propionohydrazide] (IRGANOX® MD 1024, BASF), hexamethylene glycol bis[3-(3,5-di-tert-butyl-4-hydroxyphenyl)propionate] (IRGANOX® 259, BASF), and 3,5-di-tert-butyl-4-hydroxytoluene (LOWINOX® BHT, Chemtura). The antioxidant may be present in the polymer composition in an amount ranging from about 0.01% by weight to about 1% by weight, such as in an amount ranging from about 0.05% by weight to about 0.75% by weight, such as in an amount ranging from 0.075% by weight to about 0.5 by weight based on the total weight of the polymer composition.

Light stabilizers that may be present in addition to the ultraviolet light stabilizer in the composition include sterically hindered amines. Hindered amine light stabilizers that may be used include oligomeric compounds that are N-methylated. For instance, another example of a hindered amine light stabilizer comprises ADK STAB LA-63 light stabilizer available from Adeka Palmarole. The light stabilizers, when present, can be present in the polymer composition in an amount ranging from about 0.01% by weight to about 1% by weight, such as in an amount ranging from about 0.05% by weight to about 0.75% by weight, such as in an amount ranging from about 0.075% by weight to about 0.5% by weight based on the total weight of the polymer composition.

In one embodiment, the composition may also contain one or more lubricants. The lubricant may comprise a polymer wax composition. Lubricants that may be included in the composition include, for instance, N,N′-ethylene bisstearamide or ethylene bis-stearamide (EBS) wax, which is based on monocarboxylic acids derived from naturally occurring vegetable oils. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. Lubricants can generally be present in the polymer composition in an amount ranging from about 0.01% by weight to about 1% by weight, such as in an amount ranging from about 0.05% by weight to about 0.75% by weight, such as in an amount ranging from about 0.075% by weight to about 0.5% by weight based on the total weight of the polymer composition.

In addition to the above components, the polymer composition may also contain an acid scavenger. The acid scavenger may comprise, for instance, an alkaline earth metal salt. For instance, the acid scavenger may comprise a calcium salt, such as a calcium citrate. The acid scavenger may be present in an amount ranging from about 0.001% by weight to about 1% by weight, such as in an amount ranging from about 0.005% by weight to about 0.75% by weight, such as from about 0.0075% by weight to about 0.5% by weight based on the total weight of the polymer composition.

Further, the polymer composition may also contain a compatibilizer such as a phenoxy resin. Generally, the phenoxy resin can be present in the composition in an amount ranging from about 0.01% by weight to about 1% by weight, such as in an amount ranging from about 0.05% by weight to about 0.75% by weight, such as in an amount ranging from about 0.075% by weight to about 0.5% by weight based on the total weight of the polymer composition based on the total weight of the polymer composition.

### Compound of the Polymer Composition and Forming Parts Therefrom

In order to form an article from the polymer composition of the present disclosure, the aforementioned components are compounded together to form a homogeneous blend which can be formed into any desired shape. The composition is compounded, for example, by intensively mixing or melt kneading the components at an elevated temperature, such as at a temperature that is higher than the melting point of the polyoxymethylene utilized in the polymer composition. For instance, the components can be mixed at a temperature ranging from about 160° C. to about 250° C., such as at a temperature ranging from about 180° C. to about 220° C. The conductive filler (i.e., carbon fibers) can be added using a downstream feeding unit in combination with a twin screw extruder/compounder. The carbon fibers can be added in bundles having a length of 4 to 5 millimeters, and during compounding, the carbon fibers can be chopped to their final length, which can range from 50 micrometers to about 2500 micrometers.

Without intending to be limited by theory, it is believed that the melt flow rate of the resulting polymer composition, as controlled at least in part by the melt flow rate of the base polyoxymethylene, is sufficiently high to permit an increased amount of the conductive filler component of the composition to migrate towards the surface of articles formed from the polymer, which, in turn, results in the articles exhibiting increased electrical conductivity.

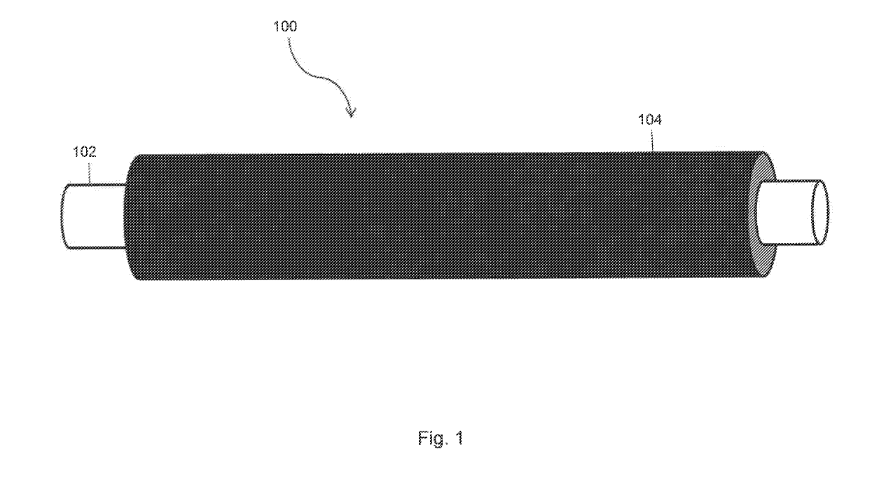

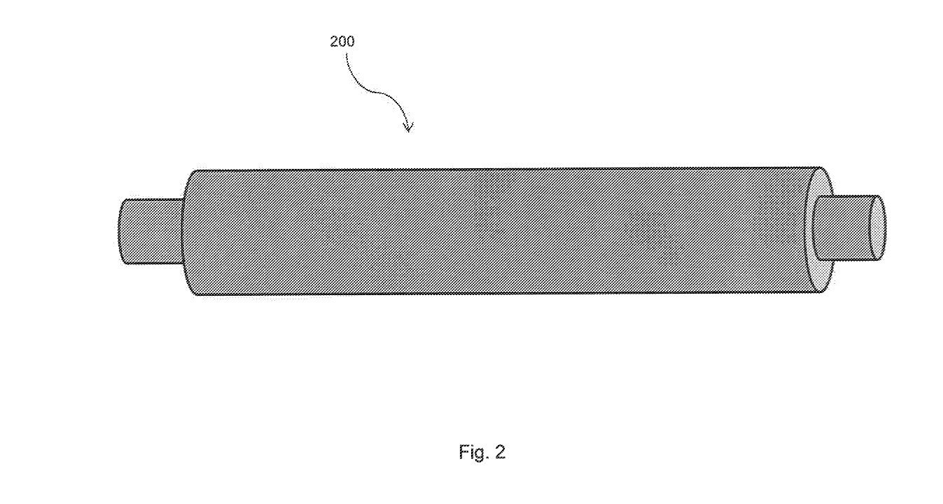

An almost limitless variety of polymer articles may be formed from the polymer composition of the present disclosure. Shaped articles can be made from the disclosed polymer composition according to the present disclosure using various different processes. In one embodiment, for instance, the shaped articles can be formed through extrusion, injection molding, thermoforming, blow molding, and rotational molding processes. Articles that can be formed from the polymer composition of the present disclosure include spindles for use in business machine applications. For comparison, FIG. 1 shows a prior art printing spindle 100, while FIG. 2 shows a printing spindle 200 formed from the polymer composition of the present disclosure. In FIG. 1, a printer spindle 100 based on the prior art is shown that includes two parts: (1) a wear resistant rod 102 formed from steel and (2) a conductive sleeve 104 wrapped around the spindle 102. In contrast, the spindle 200 of the present disclosure, represented by FIG. 2, shows a spindle 200 formed from one material, namely the polymer composition as described in the present disclosure. The polymer composition is formulated to be both electrically conductive and wear resistant such that the spindle 200 can be formed from a single material rather than a steel section surrounded by an electrically conductive sleeve as shown in FIG. 1.

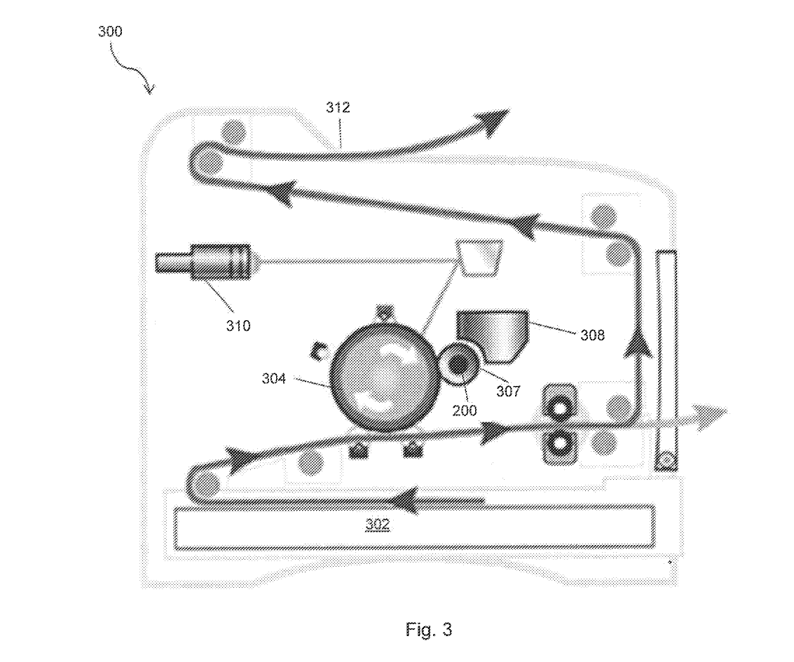

Additionally, FIG. 3 shows the printer spindle 200 of the present disclosure in use in a toner cartridge of a laser printer 300. Paper (not shown) from the paper tray 302 moves underneath the photoreceptor drum assembly 304, upon which toner (not shown) from toner hopper 308 is applied. The toner is transferred from the toner hopper 308 to the photoreceptor drum assembly 304 by toner metering roll 307, which utilizes the spindle 200. The toner adheres to the paper based upon the image projected onto the assembly 304 by the laser 310. The present disclosure may be better understood with reference to the following example.

### EXAMPLES

First, two polymer compositions of the present disclosure were compounded and then tested for resistance as a measure of electrical conductivity. The examples were also subjected to a deflection test to determine the amount of bending exhibited and to other mechanical testing to determine their modulus and strength (maximum stress). A comparative sample was also compounded and subjected to the same tests. The weight percentages of the components in the two example samples and the comparative sample shown below in Table 1:

TABLE 1

| | Weight % of Components | | | | |
|---|---|---|---|---|---|
| | Polyoxymethylene | Car- | Nu- | Anti- | Melamine |
| | 27 g/10 minute | bon | cle- | oxi- | Formaldehyde |
| Sample | melt flow rate) | Fiber | ant | dant | Scavenger |
| Example 1 | 84.95 | 13.80 | 0.96 | 0.19 | 0.10 |
| Example 2 | 79.43 | 19.40 | 0.89 | 0.18 | 0.10 |
| Comparative | 88.69 | 10.00 | 0.99 | 0.20 | 0.12 |
| Sample | | | | | |

After the examples and comparative sample were compounded based on the weight percentages of the components shown above in Table 1, the resistance of the samples was determined, as was the deflection, modulus, and maximum stress, as summarized below in Table 2. First, the melt flow rate of Example 1, Example 2, and the Comparative Sample were determined. As shown, Example 1 and Example 2 of the present disclosure, which both had increased weight percentages of carbon fibers as compared to the Comparative Sample, had lower melt flow rates. Next, the resistance was measured with an ETS Model 880 Tester, and the resistance being in the 10⁴ Ohm range indicates that the samples are electrically conductive. Additionally, the samples were subjected to a deflection test as a measure of the stiffness of the spindles. About 2-3 kilograms of pressure was laterally applied to the spindles, and the deflection of the spindles in a direction perpendicular to the application of the pressure was determined. As shown, the deflection for examples 1 and 2 was less than 0.05 mm, indicating the samples were stiff enough to be used as laser printer spindles. Further, the modulus and maximum stress (strength) were determined for Example 1, Example 2, and the Comparative Sample. As shown, an increased weight percentage of carbon fibers increases the modulus, which corresponds with an increase in stiffness. In addition, an increased weight percentage of carbon fibers also increases the strength slightly, but this change is not as noticeable as the increase in modulus due to the increase in the weight percentage of carbon fibers present.

The testing results for the polymer composition of the present disclosure are shown in Table 2:

TABLE 2

| | Test | | | | |
|---|---|---|---|---|---|
| | Surface | Volume | Deflection (mm) | | Maxi- |
| | Resis- | Resis- | Upon Application | Mod- | mum |
| | tance | tivity | of 2-3 kg | ulus | Stress |
| Sample | (Ohm) | (Ohm-cm) | Lateral Load | (MPa) | (MPa) |
| Example 1 | <10³ | <1 | <0.05 | 12391 | 79.7 |
| (13.8 wt. % | | | | | |
| Carbon | | | | | |
| Fibers) | | | | | |
| Example 2 | <10³ | <1 | <0.05 | 15083 | 80.4 |
| (19.4 wt. % | | | | | |
| Carbon | | | | | |
| Fibers) | | | | | |
| Comparative | <10⁴ | 9 | — | 9000 | 75.0 |
| (10 wt. % | | | | | |
| Carbon | | | | | |
| Fibers) | | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a base polyoxymethylene; and
carbon fibers; wherein the polymer composition has a melt flow rate of from about 4 grams per 10 minutes to about 16 grams per 10 minutes at 190° C. and a 2.16 kilogram load and a modulus of from about 10,000 MPa to about 20,000 MPa.

2. A polymer composition as defined in claim 1, wherein the base polyoxymethylene has a melt flow rate of from about 15 grams per 10 minutes to about 50 grams per 10 minutes at 190° C. and a 2.16 kilogram load.

3. A polymer composition as defined in claim 1, wherein the base polyoxymethylene is present in the polymer composition in an amount ranging from about 70% by weight to about 89% by weight based on the total weight of the polymer composition.

4. A polymer composition as defined in claim 1, wherein the carbon fibers are present in an amount ranging from about 11% by weight to about 30% by weight based on the total weight of the polymer composition.

5. A polymer composition as defined in claim 1, wherein the carbon fibers have a fiber diameter of from about 0.5 micrometers to about 25 micrometers.

6. A polymer composition as defined in claim 1, wherein the carbon fibers have a fiber length of from about 50 micrometers to about 2500 micrometers.

7. A polymer composition as defined in claim 1, wherein the carbon fibers are treated with a sizing agent.

8. A polymer composition as defined in claim 7, wherein the sizing agent is present in an amount ranging from about 0.5% by weight to about 15% by weight based on the total weight of the carbon fibers present.

9. A polymer composition as defined in claim 1, wherein the polymer composition further comprises an antioxidant, wherein the antioxidant is present in an amount ranging from about 0.01% by weight to about 1% by weight based on the total weight of the polymer composition.

10. A polymer composition as defined in claim 1, wherein the polymer composition further comprises a formaldehyde scavenger, wherein the formaldehyde scavenger is present in an amount ranging from about 0.01% by weight to about 1% by weight based on the total weight of the polymer composition.

11. A polymer composition as defined in claim 1, wherein the polymer composition further comprises a nucleant, wherein the nucleant is present in an amount ranging from about 0.01% by weight to about 2% by weight based on the total weight of the polymer composition.

12. A polymer composition as defined in claim 1, wherein the polymer composition further comprises a lubricant, wherein the lubricant is present in an amount ranging from about 0.01% by weight to about 1% by weight based on the total weight of the polymer composition.

13. A polymer composition as defined in claim 1, wherein the polymer composition further comprises a compatibilizer, wherein the compatibilizer is present in an amount ranging from about 0.01% by weight to about 1% by weight based on the total weight of the polymer composition.

14. A polymer composition as defined in claim 1, wherein the polymer composition has a surface resistance of less than about 10⁶ Ohms.

15. A polymer composition as defined in claim 1, wherein the polymer composition has a volume resistivity of less than about 100 Ohm-cm.

16. A shaped article formed from the polymer composition as defined in claim 1.

17. A shaped article as defined in claim 16, wherein the shaped article is a printer spindle.

18. A laser printer toner cartridge comprising the shaped article as defined in claim 17.

19. A shaped article as defined in claim 16, wherein when subjected to a 2-3 kilogram laterally applied load, the shaped article has a deflection of less than about 0.1 millimeters in a direction perpendicular to the direction of the laterally applied load.
